(19) United States
(12) Patent Application Publication
(10) Pub. No.: US 2016/0150195 A1
(43) Pub. Date: May 26, 2016

(54) METHODS AND SYSTEMS FOR MONITORING, RECORDING AND/OR REPORTING INCIDENTS IN PROXIMITY OF AN AIRCRAFT

(71) Applicant: Gulfstream Aerospace Corporation, Savannah, GA (US)

(72) Inventors: Jeffrey Dean Good, Savannah, GA (US); Michael Marsden, Savannah, GA (US); Jason Meade, Savannah, GA (US); Frank Manochio, Savannah, GA (US); Michael Knight, Savannah, GA (US); James Ward, Savannah, GA (US)

(21) Appl. No.: 14/553,423

(22) Filed: Nov. 25, 2014

(51) Int. Cl. H04N 7/18; B64D 45/00; B64D 47/08

(52) U.S. Cl. CPC H04N 7/188; B64D 47/08; B64D 45/00

(57) ABSTRACT

Systems and methods are provided for monitoring, recording and/or reporting information about incidents that occur within proximity of an aircraft. When an incident monitoring mode is activated, external imagers of the aircraft begin recording of video images outside the aircraft in a temporary buffer as pre-event video data. Motion sensors that detect movement in the vicinity of the aircraft, and movement sensors that detect movement of the aircraft are also enabled. When a sensor detects a trigger event, an incident report file (IRF) is saved that includes the pre-event video data that is stored in the temporary buffer. Post-event video images are then recorded in the IRF as post-event video data until a condition occurs. Alarm signals that are perceptible outside the aircraft, and an incident report message can be generated and communicated to an external computer to indicate that an incident has occurred in proximity of the aircraft.

### TECHNICAL FIELD

Embodiments of the present invention generally relate to aircraft, and more particularly relate to methods and systems for monitoring, recording and/or reporting incidents that occur within proximity of a stationary aircraft.

### BACKGROUND

When an aircraft is parked on the ground a variety of different events can take place that may cause damage to the aircraft. Examples of such events can include, but are not limited to, accidental collisions by other vehicles, impacts from wind driven objects, and vandalism or other types of contact by individuals. In many environments surveillance and monitoring equipment is not available to detect when these events occur. Unfortunately, if there is no surveillance or monitoring equipment on the ground, there is no way to collect evidence of such events taking place.

Accordingly, it is desirable to provide methods, systems and apparatus for detecting people or things that approach or come into contact with the aircraft while it is parked, and for recording and/or reporting any such incidents that occur with aircraft. It would also be desirable to provide methods, systems and apparatus that can provide alarm signals, alerts, or other indications when someone or something approaches and/or makes contact with the aircraft. It would also be desirable to provide methods, systems and apparatus that can generate alarm signals to stop such contact with the aircraft. Other desirable features and characteristics of the present invention will become apparent from the subsequent detailed description and the appended claims, taken in conjunction with the accompanying drawings and the foregoing technical field and background.

### BRIEF SUMMARY

Various non-limiting embodiments of a method and system implemented onboard an aircraft for recording information about incidents that occur within proximity of the aircraft are disclosed herein.

In one embodiment, a method is provided for for recording information about incidents that occur within proximity of an aircraft. Via a processor of the aircraft, an incident monitoring mode can be activated. In the incident monitoring mode, the processor can enable external imagers of the aircraft to acquire video images from outside the aircraft, and can record the video images in a temporary buffer as pre-event video data. The processor can also enable sensors of the aircraft including motion sensors that detect movement in the vicinity of the aircraft, and movement sensors that detect movement of the aircraft. The processor can then determine whether a trigger event has been detected by one or more of the sensors. If so, the processor can save an incident report file in a memory onboard the aircraft, and continue to record post-event video images from outside the aircraft in the incident report file until a condition occurs. The incident report file includes the pre-event video data that is currently stored in the temporary buffer when the trigger event was detected, and the post-event video images that are recorded as post-event video data.

In another embodiment, a system is provided onboard an aircraft for recording information about incidents that occur within proximity of the aircraft. The system includes a computer comprising a processor and a memory comprising a temporary buffer, external imagers. and sensors mounted onboard the aircraft. The sensors can include motion sensors that are configured to detect movement in the vicinity of the aircraft, and movement sensors that are configured to detect movement of the aircraft. The processor can enable the sensors and the external imagers when an incident monitoring mode is activated. When enabled, the external imagers can acquire video images from outside the aircraft. The video images are stored in the temporary buffer at any given time are pre-event video data. When a trigger event is detected by one or more of the sensors, the processor saves the pre-event video data that is currently in the temporary buffer in the memory as an incident report file. The processor is further configured to save post-event video images acquired from outside the aircraft in the incident report file until a condition occurs. The processor saves the post-event video images as post-event video data.

### BRIEF DESCRIPTION OF THE DRAWINGS

Embodiments of the present invention will hereinafter be described in conjunction with the following drawing figures, wherein like numerals denote like elements, and

FIG. 1 is a top view of an aircraft that includes instrumentation for monitoring, recording and/or reporting incidents that occur within proximity of the aircraft in accordance with some of the disclosed embodiments.

FIG. 2 is a block diagram of a system that can be implemented onboard an aircraft in accordance with an exemplary implementation of the disclosed embodiments.

FIG. 3 is a flowchart that illustrates a method for monitoring, recording and reporting information about incidents that occur within proximity of an aircraft in accordance with various embodiments.

### DETAILED DESCRIPTION

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention, which is defined by the claims. Furthermore, there is no intention to be bound by any theory presented in the preceding background or the following detailed description.

Systems and methods are provided for monitoring, recording and/or reporting information about incidents that occur within proximity of an aircraft. When an incident monitoring mode is activated external imagers of the aircraft begin recording of video images outside the aircraft in a temporary buffer as pre-event video data. Motion sensors that detect movement in the vicinity of the aircraft, and movement sensors that detect movement of the aircraft are also enabled, and when a trigger event has been detected by one or more of the sensors, an incident report file is saved that includes the pre-event video data that is stored in the temporary buffer, and post-event video images are then recorded in the incident report file as post-event video data until a condition occurs. Alarm signals that are perceptible outside the aircraft, and an incident report message can be generated. The incident report message can be communicated to an external computer to indicate that an incident has occurred in proximity of the aircraft.

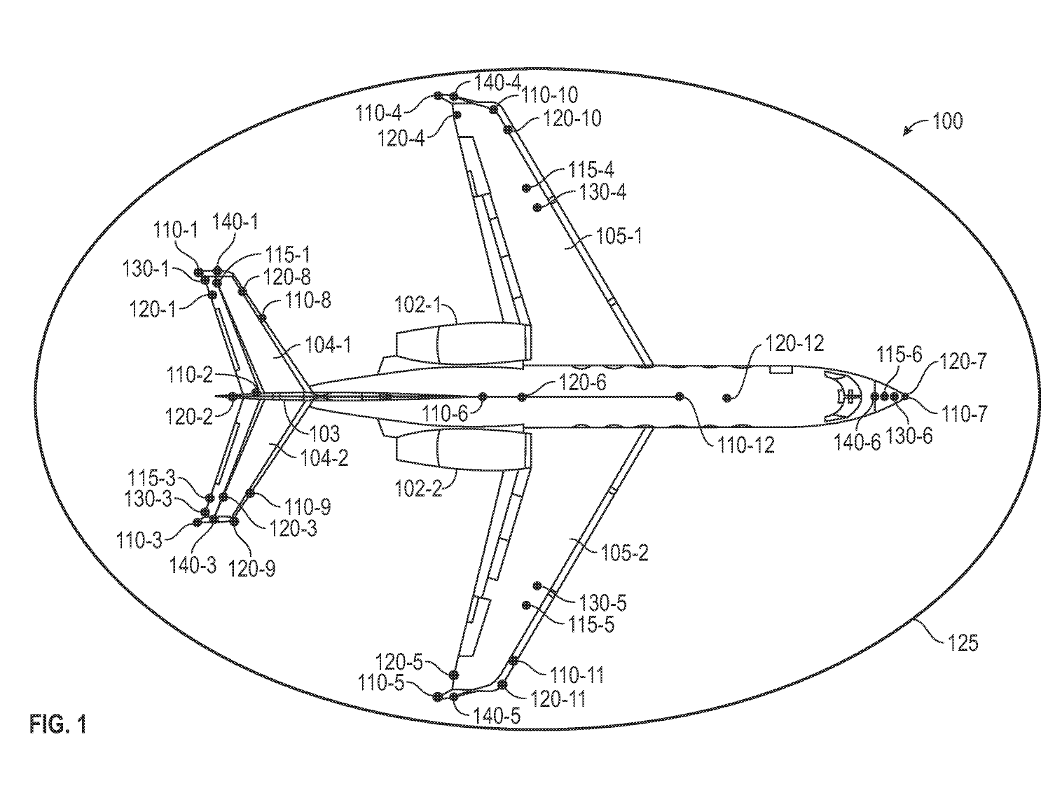

FIG. 1 is a top view of an aircraft 100 that includes instrumentation for monitoring, recording and/or reporting incidents that occur within proximity of the aircraft in accordance with some of the disclosed embodiments.

In this non-limiting implementation of the disclosed embodiments, the aircraft 100 includes a vertical stabilizer 103, two horizontal stabilizers 104-1 and 104-2, two main wings 105-1 and 105-2, and two jet engines 102-1, 102-2. Although the jet engines 102-1, 102-2 are illustrated as being mounted to the fuselage, this arrangement is non-limiting and in other implementations the jet engines 102-1, 102-2 can be mounted on the wings 105-1, 105-2, the empennage, or in any other suitable location.

In accordance with the disclosed embodiments, the aircraft also includes instrumentation that allows for monitoring, recording and/or reporting incidents that occur within proximity of the aircraft. As will be described below, this instrumentation can includes different types of sensors 110, 115, 130, 140, video imagers 120, external visual alarm equipment (not illustrated in FIG. 1), and external audio alarm equipment (not illustrated in FIG. 1) that are mounted in and/or on the aircraft 100 as part of a system for monitoring, recording and/or reporting incidents that occur within proximity of the aircraft. The number and respective locations of the sensors 110, 115, 130, 140, and the video imagers 120 are exemplary and non-limiting. The various sensors 110, 115, 130, 140 and video imagers 120 can be mounted in and/or on the aircraft 100, and can include motion sensors that are configured to detect movement in the vicinity of the aircraft 100, and movement sensors that are configured to detect movement of the aircraft 100. Depending on the implementation any number of each can be used at any location on the aircraft 100. In other implementations, either fewer or more of the sensors 110, 115, 130, 140, the video imagers 120, the external visual alarm equipment (not illustrated in FIG. 1), and the external audio alarm equipment (not illustrated in FIG. 1) can be implemented, at either the same or different locations on the aircraft 100.

Motion Sensors

Examples of motion sensors include proximity sensors 110 and motion detection sensors 115, microwave sensors that detect movement in the vicinity of the aircraft, ultrasonic sensors that detect movement in the vicinity of the aircraft, infrared sensors, and/or real-time analysis of video imagery, etc.

The motion sensors 110, 115 can be oriented so that their respective coverage areas are arranged to provide up to a full three-dimensional 360-degree detection coverage (e.g., within a volume defined by the cross-sectional area of ellipse 125) for the aircraft 100 so that any objects, including people, that enter the space surrounding the aircraft 100 (e.g., come within the vicinity of the aircraft 100) can be detected. In other words, the sensor coverage can include any area around the aircraft including a region extending above the aircraft, below the aircraft as well as adjacent to it. As used herein, the term “object” is to be construed broadly as meaning anything that can approach and/or come into contact with an aircraft. An object can refer to, for example, any material thing that is capable of approaching and/or coming into contact with an aircraft. Examples objects can include a vehicle, a projectile, a person, an animal, etc.

In the exemplary embodiment illustrated in FIG. 1, the motion sensors 110, 115 may be disposed along (e.g., embedded at) opposite rearward-facing sides of the aircraft horizontal stabilizer (or tail) 104-1, 104-2, along the aircraft vertical stabilizer 103 (or along the opposite sides of an upper aircraft horizontal stabilizer in some implementations that have a T-tail stabilizer configuration), along opposite rearward-facing sides of the wing tips, on the underside of the aircraft fuselage along the bottom-most portion of the aircraft fuselage, and along the nose of the aircraft, along the opposite forward-facing sides of the aircraft horizontal stabilizer, along opposite forward-facing sides of the wings, and along the top-most portion of the aircraft fuselage.

The motion sensors 110, 115 are used to detect objects that may be present within their detection zone (e.g., within a particular region that is in the vicinity of the aircraft 100). The motion sensors 110, 115 emit pulses (e.g., electromagnetic wave pulses, sound wave pulses, pulses of visible, ultraviolet or infrared light, etc.) which are directed and emitted as a broad beam towards a particular detection zone covering the field of view of the sensor. The duration of the pulses define a detection zone of each motion sensor. For a short period of time after each pulse is emitted by that motion sensor, waves may be reflected back towards the sensor by an object. The period of time is approximately equal to the time required for a pulse to travel from the motion sensor 110, 115 to the detection zone and for a portion of the wave that is reflected towards the motion sensor 110, 115 from an object to reach the motion sensor 110, 115. The period of time enables the distance between the motion sensor 110, 115 and an object within the detection zone to be calculated. For example, it is possible to measure the time required for a pulse to be reflected and use the time to calculate a distance between the motion sensor and a reflecting surface of the object. For instance, the distance between the motion sensor 110, 115 and the detection zone can be calculated as the speed of the sensor medium (e.g., speed of light) divided by the time delay between transmitting the pulse and receiving a reflected wave from an object within its detection zone.

The types of motion sensors 110, 115 that are employed may vary depending on the implementation. In one implementation, the motion sensors 110, 115 may be implemented using sonar or ultrasonic sensors (or transceivers) that generate and transmit sound waves. These sensors receive and evaluate the echo that is reflected back to the sensor. The time interval between sending the signal and receiving the echo can be used to determine the distance between the sensor and a detected object.

However, in other implementations, the motion sensors 110, 115 may be implemented using radar sensors, laser sensors, infrared sensors, light detection and ranging (LIDAR) sensors, infrared or laser range finders that use a set of infrared or laser sensors and triangulation techniques to detect an object and to determine its position with respect to the aircraft, distance from the aircraft, etc. For example, in one embodiment, the motion sensors 110, 115 can be infrared sensors that include an infrared light transmitter and receiver. Short light pulses are transmitted by the transmitter, and when at least some light pulses are reflected by an object, the object is detected by the receiver. Further, in one implementation, information from one or more of these types of sensors can be used in conjunction with video data from the video imagers 120 to detect moving objects.

The range of distances that are within the field of view (FOV) of the motion sensors 110, 115 define object detection zones for each motion sensor 110, 115. The range of distances that are within the field of view of the motion sensors 110, 115 can vary depending on the implementation and design of the aircraft 100. In some embodiments, field of view and range of the motion sensors 110, 115 can be varied. For example, the size and location of the detection zone relative to the motion sensor 110, 115 (and therefore the aircraft 100) can be varied.

Movement Sensors

The movement sensors 130, 140 are used to detect movement of the aircraft 100. Non-limiting examples of movement sensors can include the accelerometers 130 and inertial sensors 140. In addition, the movement sensors can also include vibration sensors that detect movement of the aircraft 100, force sensors that detect movement of the aircraft 100, pressure sensors that detect movement of the aircraft 100, GPS sensors that detect position changes and thus movement of the aircraft, etc. In one embodiment, at least some of the movement sensors can be inertial sensors 140 that are part of an inertial reference system (IRS). As is known in the art, the IRS is a self-contained navigation system that includes inertial detectors, such as accelerometers, and rotation sensors (e.g., gyroscopes) to automatically and continuously calculate the aircraft's position, orientation, heading and velocity (direction and speed of movement) without the need for external references once it has been initialized.

Video Imagers

The video imagers 120-1 . . . 120-12 are disposed at the locations on the aircraft 100 and oriented so that their respective fields of view are arranged to provide up to a full three-dimensional 360-degree effective field of view 125 of the aircraft 100 so that video images of any objects in the vicinity of the aircraft 100 can be acquired and monitored. In the exemplary embodiment illustrated in FIG. 1, video imagers 120-1 and 120-3 may be disposed along opposite rearward-facing sides lower aircraft horizontal stabilizers 104-1 and 104-2, video imager 120-2 may be disposed along the aircraft vertical stabilizer 103, video imagers 120-4, 120-5 may be disposed along opposite rearward-facing sides of the wing tips, video imager 120-6 may be disposed along the bottom-most portion of the aircraft fuselage to allow viewing of at least part of the region below the aircraft, the video imager 120-7 may be disposed along the nose of the aircraft, video imagers 120-8, 120-9 may be disposed along the opposite forward-facing sides of the aircraft horizontal stabilizer, video imagers 120-10, 120-11 may be disposed along opposite forward-facing sides of the wings, and video imager 120-12 may be disposed along the top-most portion of the aircraft fuselage to allow viewing of at least part of the region above the aircraft. It is noted that in other implementations, the aircraft may employ a T-tail stabilizer configuration that includes a vertical stabilizer and an upper horizontal stabilizer at the top of the vertical stabilizer. With such T-tail stabilizer configurations, additional video imagers (and sensors) can be located along the opposite sides of the upper horizontal stabilizer.

Each of the video imagers 120-1 . . . 120-12 can be used to acquire video images of a particular region around the aircraft (including any objects that may be present in the vicinity of the aircraft 100), and to generate video signals (referred to herein as video image signals). Each of the video imagers 120-1 . . . 120-12 is capable of acquiring video images of a particular region (within its field of view) that is in the vicinity of the aircraft 100.

Each of the video imagers 120-1 . . . 120-12 are operable to acquire images of a corresponding detection zone. The images can include detected objects, when present, and therefore, the video imagers 120-1 . . . 120-12 are operable to acquire an image of objects that might be located within a predetermined range of distances and within a field of view associated with the video imagers 120-1 . . . 120-12.

The video imagers 120-1 . . . 120-12 that are employed may vary depending on the implementation. In general, each video imager can be implemented using a video camera or other image capture apparatus. In some implementations, the video imagers 120-1 . . . 120-12 may be implemented using cameras such as high-definition video cameras, video cameras with low-light capability for night operations and/or cameras with infrared (IR) capability, or any combinations thereof, etc.

The field of view of the video imagers 120-1 . . . 120-12 can vary depending on the implementation and design of the aircraft 100 so that the detection zone can be varied either by the operator or automatically depending on other information. In some embodiments, the field of view of the video imagers 120-1 . . . 120-12 can be fixed, while in others it can be adjustable. For example, in one implementation, the video imagers 120 can be cameras with a variable focal length (zoom lens) which can be varied to vary the FOV and/or direction of view. This feature can be used to vary the range and field of view based on the surrounding area so that the location and size of the space being imaged can be varied. When the video imagers 120-1 . . . 120-12 have an adjustable FOV (e.g., a variable FOV), a processor (not illustrated in FIG. 1) can command the camera lens to a preset FOV. In general, the field of view of the video imagers 120-1 . . . 120-12 is typically much wider than in comparison to that that of the sensors 110, 115. The range of the video imagers 120-1 . . . 120-12 can also vary depending on the implementation and design of the aircraft 100

The external visual alarm equipment (not illustrated in FIG. 1) can include things such as external lights that are mounted on the aircraft 100. The external audio alarm equipment (not illustrated in FIG. 1) can include audio elements such as speakers, horns, bells, etc. that are mounted on the aircraft 100. As will be described in greater detail below, when an object (not illustrated) is detected by any of the sensors 110, 115, 130, 140, apparatus, including the external visual alarm equipment (not illustrated in FIG. 1) and/or external audio alarm equipment (not illustrated in FIG. 1) of the aircraft 100, can generate alarm signals that are perceptible outside the aircraft 100 to provide a warning that the object has been detected.

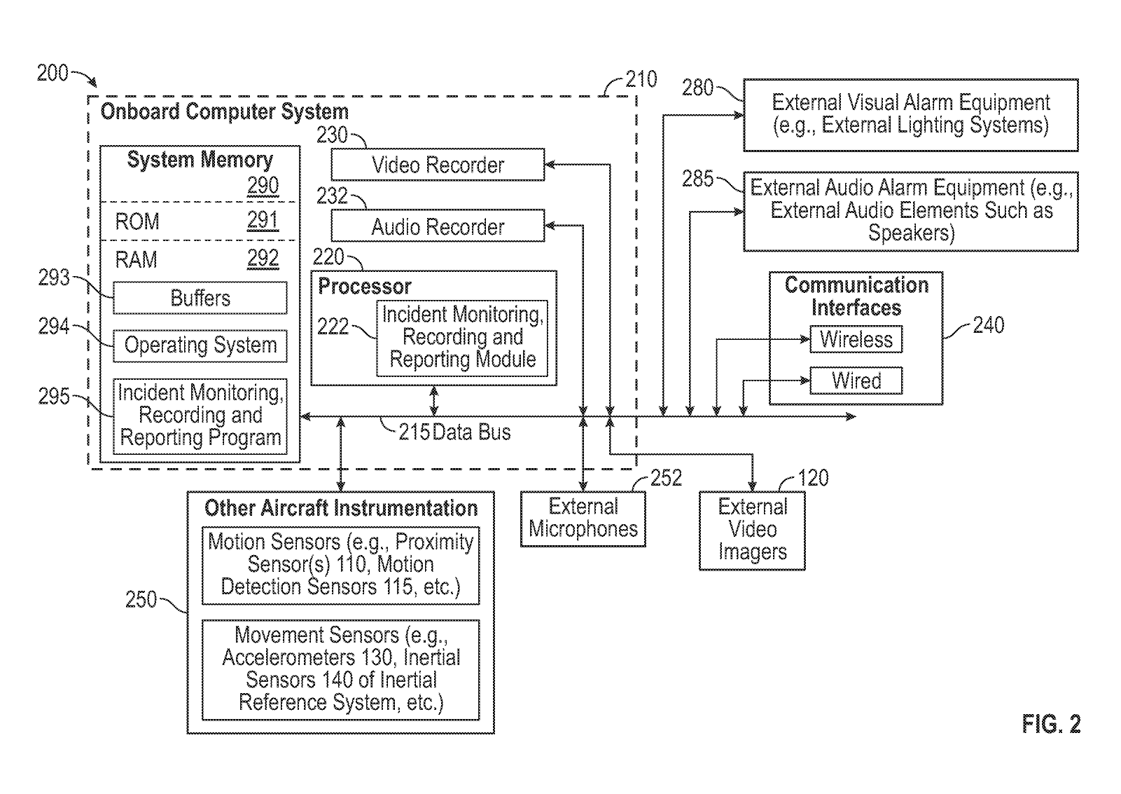

FIG. 2 is a block diagram of a system 200 that can be implemented onboard an aircraft in accordance with an exemplary implementation of the disclosed embodiments. As used herein, the term “onboard” when used to describe an apparatus associated with an aircraft can mean that the apparatus is situated on or in, mounted on or integrated within the aircraft. The system 200 of FIG. 2 can be used for monitoring, recording and reporting information about incidents that occur in proximity of the aircraft 100, for example, when the aircraft 100 is located on the ground and stationary (e.g., parked).

The system 200 includes an onboard computer system 210, also referred to herein as an “onboard computer,” external video imagers 120 mounted in and/or on the aircraft 100 and a video recorder 230 for recording video images generated by the video imagers 120, communication interfaces 240 that can be used to communicate signals to other internal and external communication interfaces, aircraft instrumentation 250 that includes various sensors mounted in and/or on the aircraft 100, external microphones 252 mounted in and/or on the aircraft 100 and an audio recorder 232 for recording audio information captured by the microphones 252, external visual alarm equipment/devices 280 that are mounted in and/or on the exterior of the aircraft 100, external audio alarm equipment/devices 285 that are mounted in and/or on the exterior of the aircraft 100. The system 200 will now be described in greater detail below with reference to FIG. 2.

The communication interfaces 240 can include wired communication interfaces and wireless communication interfaces. The wireless communication interfaces are operatively and communicatively coupled antennas (not illustrated) that can be external to the onboard computer 210. The wireless communication interfaces can communicate with external wireless communication interfaces via one or more of the wireless communication links (not illustrated). The wireless communication interfaces and wireless communication links can be implemented using any known types of wireless technologies including, but not limited to, Bluetooth, near infrared, WLAN, cellular, etc. Without limitation, the antennas can include, for example, a WLAN antenna that can be used to communicate information with a WLAN access point or interface over a WLAN communication link, a Bluetooth antenna that can be used to directly communicate information to/from another Bluetooth-enabled device, over a Bluetooth communication link, and a near infrared network antenna that can be used to directly communicate information to another device over a near infrared communication link, a cellular network antenna that can be used to communicate information to/from a cellular base station over a cellular communication link.

The aircraft instrumentation 250 includes various sensors mounted in and/or on the aircraft 100. In general, the sensors can include motion sensors that are configured to detect movement (e.g., of objects including people) in the vicinity of the aircraft 100, and movement sensors that are configured to detect movement of and/or contact with the aircraft 100. Examples of motion sensors can include proximity sensors 110, motion detection sensors 115, microwave sensors that detect movement in the vicinity of the aircraft, ultrasonic sensors that detect movement in the vicinity of the aircraft, MEMS devices, etc. Examples of movement sensors are described above. Although not illustrated for sake of simplicity, the aircraft instrumentation 250 can also include, for example, other elements of an Inertial Reference System (IRS), the elements of a Global Position System (GPS), which provides GPS information regarding the position and speed of the aircraft, etc.

The aircraft 100 can also include various types of alarm equipment located in and/or on the aircraft 100 including visual alarm equipment/devices 280 and audio alarm equipment/devices 285. The visual alarm equipment/devices 280 that are located in or on the exterior of the aircraft 100 can include any known types of visual alarm equipment and the audio alarm equipment/devices 285 can include any known types audio elements

The onboard computer 210 includes a data bus 215, a processor 220, and system memory 290. The data bus 215 is used to carry signals communicated between the processor 220, and any of the other blocks of FIG. 2.

The system memory 290 can include non-transitory computer readable storage media including non-volatile memory (such as ROM 291, flash memory, etc.), volatile memory (such as RAM 292), or some combination of the two. A portion of the RAM 292 can be used to implement temporary buffers 293 that will be described in greater detail below. As is known in the art, a “buffer” refers to a portion of a physical memory storage that is used to temporarily store data for a time frame to determine whether that data is need by another computer process or can be discarded. For instance, the temporary buffers 293 described herein can be used to temporarily store a certain amount of video data and/or audio data.

The RAM 292 stores software instructions for an operating system 294, and software instructions for an incident monitoring, recording and reporting program 295.

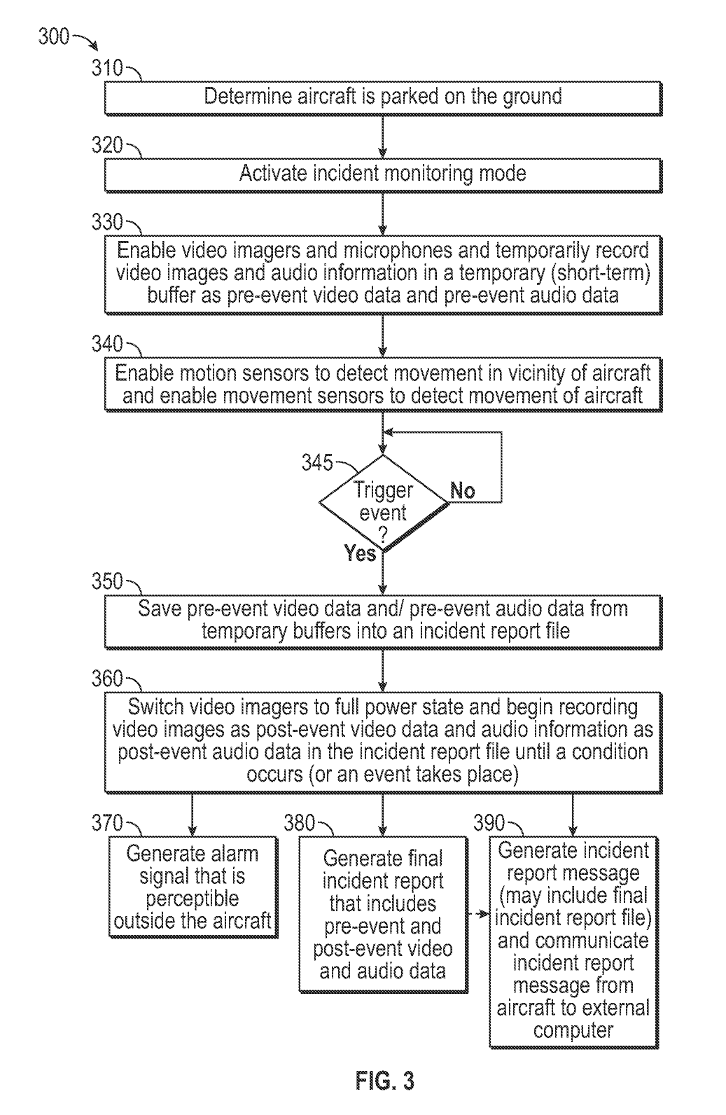

As will be described below, when an incident monitoring mode is activated, the processor 220 loads and executes instructions of the incident monitoring, recording and reporting program 295 (stored in system memory 290) to implement an incident monitoring, recording and reporting module 222 at processor 220. The processor 220 to perform various acts described herein with reference to FIGS. 2 and 3.

For example, in one embodiment, when the incident monitoring mode is activated, the processor 220 enables the external imagers 120, the external microphones 252 and the sensors. When enabled, video images from the external imagers 120 are recorded by video recorder 230 and temporarily stored in one of the temporary buffers 293 as pre-event video data, and audio information captured by the external microphones 252 can be recorded by audio recorder 232 and temporarily stored in another one of the temporary buffers 293 as pre-event audio data. Each of the buffers 293 holds a limited amount of data for a limited time period. As the buffers 293 fill with newer data, older data is discarded to make room for the newer data. When a trigger event is detected by one or more of the sensors, the processor 220 creates an incident report file and saves the pre-event video data and the pre-event audio data that is currently stored in the temporary buffers 293 to memory 290 in the incident report file. The processor 220 also continues to save post-event video images and post-event audio information in the incident report file as post-event video data and post-event audio data until a condition occurs, at which point the processor 220 can also generate a final incident report file and save it to memory 290. The final incident report file can include the pre-event video data and the post-event video data that includes image(s) of an object or person approaching and/or coming into contact with the aircraft 100. In some implementations, the final incident report file can also include the pre-event audio data and the post-event audio data, which includes audio information or sound that is attributable to (or associated with) the object or person that is approaching and/or coming into contact with the aircraft 100.

In addition, when the trigger event is detected by one or more of the sensors, the processor 220 can also generate a signal that causes an alarm signal to be generated that is perceptible outside the aircraft 100. For instance, one of the external audio alarm equipment/devices 285 (e.g., external audio elements) can generate an audible alarm signal and the external visual alarm equipment/devices 280 (e.g., external lighting system) can be activated to generate a visual alarm signal.

The processor 220 can also generate an incident report message and communicate the incident report message from the aircraft 100 to an external computer (not illustrated). The incident report message includes an indication that an incident has occurred in proximity of the aircraft 100, and may also optionally include the final incident report file.

The incident monitoring, recording and reporting program 295 can include, among other things, a sensor program module, a video imager program module, and an alarm generator module.

The sensor program module can be programmed to control the field of view of the sensors, and to process detection signals from the sensors whenever an object is detected by the sensors as approaching or contacting the aircraft 100.

The video imager program module is programmed to control characteristics (e.g., the field of view) of the video imagers and video image signals generated by the video imagers. The video imager program module also controls processing of the video image signals. In some implementations, the video imager program module may be configured to process images (e.g., raw camera data) received from the video imagers so as to determine the range of an object from the video imagers, movement of an object, etc. This data can be used by the processor 220 to perform one or more tasks as described below.

The alarm generator module is configured to receive detection signals communicated from any of the sensors. Upon receiving a detection signal from a particular sensor that has detected an object, the processor 220 determines that an object is located in proximity to and/or contacting the aircraft 100, and generates an alarm generator signal that it communicates to one or more apparatus located in and/or on the aircraft 100 (e.g., visual alarm equipment/devices 280 or audio alarm equipment/devices 285).

Further operational details of the system 200 will now be described with reference to FIG. 3.

FIG. 3 is a flowchart that illustrates a method 300 for monitoring, recording and reporting information about incidents that occur within proximity of an aircraft 100 in accordance with various embodiments. The method 300 of FIG. 3 will be described below with reference to FIGS. 1-2 to explain how the method 300 could be applied in the context of one exemplary, non-limiting embodiment. As a preliminary matter, it should be understood that steps of the method 300 are not necessarily presented in any particular order and that performance of some or all the steps in an alternative order is possible and is contemplated. The steps have been presented in the demonstrated order for ease of description and illustration. Further, steps can be added, omitted, and/or performed simultaneously without departing from the scope of the appended claims. As such, it is noted that all the blocks/tasks/steps do not necessarily need to be performed in every implementation. In some implementations one or any combination of blocks/tasks/steps of FIG. 3 can be performed. For example, Blocks 330, 340 and 345 are shown separately, but in some implementations, these acts/steps take place at the same time. As another example, blocks 370 through 390 are optional and are not performed in all implementations of method 300. It should also be understood that the illustrated method 300 can end at any time. In certain embodiments, some or all steps of this process, and/or substantially equivalent steps, are performed by execution of processor-readable instructions stored or included on a non-transitory processor-readable medium, for example. For instance, references to a processor performing functions of the present disclosure refer to any one or more interworking computing components executing instructions 295, such as in the form of an algorithm, provided on a processor-readable medium, such as a memory 290 associated with a processor 220 of an onboard computer 210.

Method 300 begins at 310, when a processor 220 of the aircraft 100 determines that the aircraft 100 is on the ground, stationary and/or parked (e.g., not moving, and powered off, etc.). The method 300 will not proceed from 310 until the processor 220 makes this determination. This way, when the aircraft is in the air (i.e., not on the ground), or alternatively is on the ground and is moving, the system is effectively disabled. In one implementation, when the aircraft is on the ground and moving above a certain ground speed, the system is effectively disabled to prevent unnecessary recording and reporting, unnecessary generation of alarms and incident report messages, etc. In some implementations, when the aircraft is moving, the processor 220 can place the system 200 in a buffer only more so that small clips of video information are stored (e.g., a few seconds or minutes of video) in non-volatile memory so that those small clips can be retrieved if needed.

At 320, the processor 220 can activate an incident monitoring mode. In one embodiment, the incident monitoring mode can be automatically activated any time the processor 220 determines (at 310) that the aircraft is on the ground, stationary and/or parked. In an alternative embodiment, at 320, the processor 220 can present an option at 320 to a user (e.g., a person such as a pilot, crew, ground personnel, etc.) via a display or computer monitor to activate the incident monitoring mode via a user input or activation command.

At 330, the processor 220 transmits a signal (or signals) to enable external imagers 120 and/or microphones 252 of the aircraft 100. As the video imagers acquire video images of various regions around the aircraft 100 that correspond to each of the video imagers, a video recorder 230 starts temporarily recording video images (from outside the aircraft 100) in a temporary buffer 293 as pre-event video data. In some embodiments, as the microphones 252 acquire audio outside the aircraft 100, the audio recorder 232 temporarily records the audio information in another temporary buffer 293 as pre-event audio data. The temporary buffer(s) 293 are designed to hold only a limited amount of the pre-event video data and/or pre-event audio data for a limited amount of time before it is discarded unless it is directed to be stored due to a detected event.

At 340, the processor 220 transmits a signal to enable sensors of the aircraft 100. As noted above, the sensors can include motion sensors that detect movement in the vicinity of the aircraft 100 (e.g., proximity sensors 110, motion detection sensors 115, microwave sensors, ultrasonic sensors), and movement sensors that detect movement of the aircraft 100 (e.g., accelerometers 130, inertial sensors 140, vibration sensors, force sensors, pressure sensors, etc.).

After the imagers 120, sensors and/or microphones 252 have been enabled, the aircraft 100 can be placed in either a “full” incident monitoring mode so that movement near the aircraft and/or movement of the aircraft 100 can be detected. In some embodiments, the aircraft 100 can be placed in a partial incident monitoring mode in which only some of the functionality is enabled (e.g., only detect movement near the aircraft 100 or only detect movement of the aircraft 100). At 345, the processor 220 regularly checks/monitors to determine whether a trigger event has occurred. The method 300 loops at 345 until a trigger event occurs. In some embodiments, the processor 220 determines that a trigger event has occurred when it receives a detection signal from one or more of the sensors. The detection signal indicates that one or more of the sensors has detected movement near the aircraft 100, and/or movement of the aircraft 100. In other words, in one implementation of 345, the processor 220 determines whether any detection signals have been received from any of the sensor 250, and hence whether any potential incidents have been detected by any of the sensors. For instance, when a sensor, for example, detects an object or person in vicinity of the aircraft, it transmits a detection signal to the processor 220 to indicate that the object or person has been detected near the aircraft. In some implementations, the detection signal may optionally include information regarding the distance between the sensor and the object/person as well as the direction in which the object/person has been detected.

When a trigger event has been detected by one or more of the sensors, method 300 proceeds to 350 and 360 (and optionally to 370, 380 and/or 390).

At 350, the processor creates and saves an incident report file in memory 290 so that a record of any incidents in proximity of the aircraft can be created. The incident report file includes the pre-event video data and/or the pre-event audio data that is currently stored in the temporary buffer(s) 293.

In addition, as the video imagers continue to acquire video images of various regions around the aircraft 100 that correspond to each of the video imagers, at 360, the video recorder 230 begins permanently temporarily recording video images (from outside the aircraft 100) in the incident report file as post-event video data, and continues to do so until a condition (or event) occurs. For example, in some cases, a timer, a counter or combination of both may begin to execute after the trigger event occurs and needs to expire or be satisfied before recording stops. In other cases, recording will continue until a stop recording signal is received by the processor (e.g., until someone deactivates the incident monitoring mode). Similarly, in some embodiments, as the microphones 252 continue to acquire audio outside the aircraft 100, at 360, the audio recorder 232 can also permanently record that audio information in the incident report file as post-event audio data, and continues to do so until the condition (or event) occurs.

Depending on the implementation, method 300 may then proceed to one or more of blocks 370, 380 and 390. In other words, acts at blocks 370, 380 and 390 are optional and do not necessarily need to be performed during every implementation. In some implementations any combination of blocks 370, 380, and 390 can be performed.

At 370, the aircraft can generate an alarm signal that is perceptible outside the aircraft 100. The alarm signal can vary depending on the implementation, and can generally be, for example, any known type of alarm signal that is designed to provide an alarm either audibly (e.g., an audible alarm) or visually (e.g., a flashing light). For example, in some embodiments, when the trigger event has been detected by one or more of the sensors, an external audio element 285 of the aircraft 100 can be activated to generate an audible alarm signal (e.g., beep, siren, etc.) that is perceptible outside the aircraft 100. In other embodiments, an external visual alarm equipment/devices 280 (e.g., external lighting system) of the aircraft 100 can be activated (e.g., in response to a signal received from the processor) to generate a visual alarm signal (e.g., flashing light, etc.) that is perceptible outside the aircraft 100. The alarm signal (or signals) can serve as an alert that an incident is occurring outside the aircraft. For instance, when someone is about to vandalize or is vandalizing the aircraft, the alarm signal can serve as a deterrent and scare the person away. As another example, if a vehicle is driving towards the aircraft and about to collide with it, then an alarm will be generated. As will be described below, in both examples, a video and/or audio record of the incident will be recorded.

At 380, the processor 220 may also generate a final incident report file, and save the final incident report file in the memory 290. The final incident report file can include the pre-event video data and the post-event video data and/or the pre-event audio data and post-event audio data, as well as other information such as time, date, location, automated weather conditions reporting at the airport, information regarding trigger events and specific sensors that generated the detection signals, data measured by the sensors that generated the detection signals, information regarding date, time, and location of the incident, etc. The pre-event video data and the post-event video data can includes image(s) of an object approaching and/or contacting the aircraft 100, whereas the pre-event audio data and the post-event audio data can include audio information or sound attributable to the object approaching and/or contacting the aircraft 100. As used herein, the object can refer to a person or thing that approaches and/or comes into contact with the aircraft 100. This way, a video and/or audio record is created of any object that is involved in an incident with the aircraft. For instance, when someone is vandalizes the aircraft, or an object such as a vehicle collides with the aircraft, a video and/or audio record of the incident will be recorded in the incident report file, and can be communicated to an external computer. This can help reduce the amount of time required to investigate any incidents that occur, and can save time needed to identify who or what was responsible for damage to the aircraft. It can also provide a record of any person or vehicle that approached the aircraft even if no damage to the aircraft or movement occurred.

At 390, the processor 220 can generate an incident report message and wirelessly communicate the incident report message from the aircraft 100 to an external or remote computer (e.g., that is outside the aircraft) to notify someone that an incident has occurred. The incident report message can be communicated in any known form including, for example, e-mail, text or short message service (SMS), or via an automated phone call, for example, using a pre-recorded message. The incident report message includes information indicating that an incident has taken place in proximity of that particular aircraft, and can include other information such as the date and time the incident occurred, the location of the aircraft when the incident occurred, etc. In some embodiments, the incident report message can also include the final incident report file, while in other embodiments it does not. The external computer can be a computer that is associated with the owner of the aircraft, a computer that is part of a ground support network, a server associated with a maintenance tracking software program that is part of a Computerized Maintenance Program (CMP), a computer associated with an airport security unit or a law enforcement agency, etc.

The flowchart that is illustrated in FIG. 3 is exemplary, and is simplified for sake of clarity. In some implementations, additional blocks/tasks/steps can be implemented even though they are not illustrated in FIG. 3 for sake of clarity. These additional blocks/tasks/steps may occur before or after or in parallel and/or concurrently with any of the blocks/tasks/steps that are illustrated in FIG. 3. It is also noted that some of the blocks/tasks/steps illustrated in FIG. 3 may be optional and do not need to be included in every implementation of the disclosed embodiments. In some implementations, although not illustrated, the presence or absence of certain conditions may need to be confirmed prior to execution of a block/task/step or prior to completion of a block/task/step. In other words, a block/task/step may include one or more conditions that are to be satisfied before proceeding from that block/task/step to the next block/task/step. For example, in some cases, a timer, a counter or combination of both may execute and need to be satisfied before proceeding to the next block/task/step of the flowchart. As such, any block/task/step can be conditional on other blocks/tasks/steps that are not illustrated.

It is also noted that there is no order or temporal relationship implied by the flowchart of FIG. 3 unless the order or temporal relationship is expressly stated or implied from the context of the language that describes the various blocks/tasks/steps of the flowchart. The order of the blocks/tasks/steps can be varied unless expressly stated or otherwise implied from other portions of text.

In addition, in some implementations, FIG. 3 may include additional feedback or feed-forward loops that are not illustrated for sake of clarity. The absence of a feedback or a feed-forward loop between two points of the flowchart does not necessarily mean a feedback or feed-forward loop is not present between the two points. Likewise, some feedback or feed-forward loops may be optional in certain implementations. Although FIG. 3 is illustrated as including a single iteration this does not necessarily imply that the flowchart does not execute for a certain number of iterations or continuously or until one or more conditions occur.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for recording information about incidents that occur within proximity of an aircraft, the method comprising:
activating, via a processor of the aircraft, an incident monitoring mode, the activating including:
enabling, via the processor of the aircraft, external imagers of the aircraft to acquire video images from outside the aircraft, and recording the video images in a temporary buffer as pre-event video data;
enabling, via the processor of the aircraft, sensors of the aircraft, wherein the sensors comprise: motion sensors that detect movement in the vicinity of the aircraft, and movement sensors that detect movement of the aircraft;
determining, at the processor, whether a trigger event has been detected by one or more of the sensors;
when the trigger event has been detected by one or more of the sensors:
saving an incident report file in a memory onboard the aircraft, the incident report file comprising: the pre-event video data that is currently stored in the temporary buffer when the trigger event was detected; and
continuing to record post-event video images from outside the aircraft in the incident report file until a condition occurs, wherein the post-event video images are recorded as post-event video data.

2. The method according to claim 1, when the trigger event has been detected by one or more of the sensors, further comprising:
generating an alarm signal that is perceptible outside the aircraft.

3. The method according to claim 2, when the trigger event has been detected by one or more of the sensors, further comprising:
generating, via an external audio element of the aircraft, an audible alarm signal that is perceptible outside the aircraft.

4. The method according to claim 2, when the trigger event has been detected by one or more of the sensors, further comprising:
generating, via an external lighting system of the aircraft, a visual alarm signal that is perceptible outside the aircraft.

5. The method according to claim 1, when the trigger event has been detected by one or more of the sensors, further comprising:
generating, via the processor of the aircraft, a final incident report file, and saving the final incident report file in the memory, wherein the final incident report file comprises: the pre-event video data and the post-event video data.

6. The method according to claim 5, when the trigger event has been detected by one or more of the sensors, further comprising:
generating, via the processor of the aircraft, an incident report message and communicating the incident report message from the aircraft to an external computer, wherein the incident report message comprises: an indication that an incident has occurred in proximity of the aircraft.

7. The method according to claim 6, wherein the incident report message further comprises: the final incident report file.

8. The method according to claim 5, the activating further comprising:
enabling, via the processor of the aircraft, external microphones of the aircraft for acquiring audio information from outside the aircraft, and temporarily recording the audio information acquired by the external microphones in another temporary buffer as pre-event audio data.

9. The method according to claim 8, wherein saving further comprises:
saving the pre-event audio data that is stored in the other temporary buffer in the incident report file; and
further comprising:
recording post-event audio information from outside the aircraft until the condition occurs, and saving the post-event audio information in the incident report file as post-event audio data.

10. The method according to claim 9, wherein the final incident report file further comprises: the pre-event audio data and the post-event audio data.

11. A system implemented onboard an aircraft for recording information about incidents that occur within proximity of the aircraft, the system comprising:
external imagers mounted onboard the aircraft;
sensors mounted onboard the aircraft, the sensors comprising: motion sensors that are configured to detect movement in the vicinity of the aircraft, and movement sensors that are configured to detect movement of the aircraft;
a computer mounted onboard the aircraft and comprising:
a memory comprising a temporary buffer; and
a processor configured to:
enable the sensors and the external imagers when an incident monitoring mode is activated, wherein the external imagers, when enabled, acquire video images from outside the aircraft, wherein video images that are in the temporary buffer at any given time are pre-event video data; and
when a trigger event has been detected by one or more of the sensors, wherein the processor is further configured to save the pre-event video data that is currently in the temporary buffer in the memory as an incident report file, and
wherein the processor is further configured to save post-event video images acquired from outside the aircraft in the incident report file until a condition occurs, wherein the processor saves the post-event video images as post-event video data.

12. The system according to claim 11, when the trigger event has been detected by one or more of the sensors, wherein the processor is further configured to generate a signal that causes an alarm signal to be generated that is perceptible outside the aircraft.

13. The system according to claim 12, wherein the system further comprises:
an external audio element mounted onboard the aircraft, and wherein the alarm signal is an audible alarm signal generated by the external audio element.

14. The system according to claim 12, wherein the system further comprises:
an external lighting system mounted onboard the aircraft, and wherein the alarm signal is a visual alarm signal generated by the external lighting system.

15. The system according to claim 11, wherein the processor is further configured to generate a final incident report file, and save the final incident report file in the memory, wherein the final incident report file comprises: the pre-event video data and the post-event video data, wherein at least one of the pre-event video data and the post-event video data comprises: at least one image of an object that is approaching or contacting the aircraft.

16. The system according to claim 15, when the trigger event has been detected by one or more of the sensors, wherein the processor is further configured to generate an incident report message and communicate the incident report message from the aircraft to an external computer, wherein the incident report message comprises: an indication that an incident has occurred in proximity of the aircraft.

17. The system according to claim 16, wherein the incident report message further comprises: the final incident report file.

18. The system according to claim 15, wherein the system further comprises:
another temporary buffer; and
external microphones mounted onboard the aircraft, and
when the incident monitoring mode is activated, wherein the processor is further configured to enable external microphones and to start recording audio information acquired by the external microphones from outside the aircraft in the other temporary buffer as pre-event audio data.

19. The system according to claim 18, when the trigger event has been detected by one or more of the sensors, wherein the processor is further configured to save the pre-event audio data that is stored in the other temporary buffer in the incident report file, and to save post-event audio information occurring outside the aircraft until the condition occurs, wherein the processor saves the post-event audio information in the incident report file as post-event audio data.

20. The system according to claim 19, wherein the final incident report file further comprises: the pre-event audio data and the post-event audio data, wherein at least one of the pre-event audio data and the post-event audio data comprises: sound attributable to the object that is approaching or contacting the aircraft.
